(19) United States
(12) Patent Application Publication
(10) Pub. No.: US 2014/0224227 A1
(43) Pub. Date: Aug. 14, 2014

(54) CONTROL UNIT OF INTERNAL COMBUSTION ENGINE EQUIPPED WITH SUPERCHARGER

(71) Applicants: Satoshi Yoshizaki, Gotemba-shi (JP); Kiyonori Takahashi, Susono-shi (JP); Masashi Shibayama, Kobe-shi (JP)

(72) Inventors: Satoshi Yoshizaki, Gotemba-shi (JP); Kiyonori Takahashi, Susono-shi (JP); Masashi Shibayama, Kobe-shi (JP)

(73) Assignee: TOYOTA JIDOSHA KABUSHIKI KAISHA, Toyota-shi, Aichi-ken (JP)

(21) Appl. No.: 14/122,471

(22) PCT Filed: Jul. 5, 2011
(86) PCT No.: PCT/JP2011/065372

§ 371 Date: Feb. 19, 2014

(51) Int. Cl. F02D 23/02

(52) U.S. Cl. CPC F02D 23/02
USPC 123/559.1

(57) ABSTRACT

According to the present invention, torque controllability may be improved in a situation in which there is a gap between a required torque and a current torque based on a supercharge delay of a supercharger when calculation of a target throttle divergence using an air reverse model is applied to a supercharged internal combustion engine. Although the control unit of the present invention usually determines the required torque as a target torque, the control unit determines a value lower than the current torque when a reduction direction change occurs in the required torque while there is the gap between the required torque and the current torque. Desirably, the control unit determines a target torque reduction correspondingly to a decrease in the required torque, and determines a target torque reduction subtracted from the current torque as the target torque. The control unit calculates a target air volume from the determined target torque, and calculates the target throttle divergence by using the air reverse model and based on the target air volume.

### TECHNICAL FIELD

The present invention relates to a control unit of a supercharged internal combustion engine which has a throttle. More specifically, the present invention relates to a control unit of a supercharged internal combustion engine which is configured to calculate a target throttle opening based on a target air quantity with use of an air inverse model.

### BACKGROUND ART

A method of setting a target throttle opening by calculation with use of an air inverse model is known as disclosed in Japanese Patent Laid-Open No. 2010-053705. The air inverse model is an inverse model of an air model in which a response of an air quantity to an operation of a throttle is modeled and is expressed in mathematical form. A throttle opening required to achieve a required torque is calculated by calculating a target air quantity from the required torque and inputting it into the air inverse model.

Calculation procedure of the target throttle opening with use of the air inverse model can be applied to a control of a supercharged internal combustion engine as well as a naturally-aspirated internal combustion engine. However, in this case, there exist the following issues which are peculiar to the supercharged internal combustion engine.

In the case of the supercharged internal combustion engine, a situation where there is a large gap between the required torque and a current torque persists for a while from a start of acceleration due to a response delay of an air quantity caused by a supercharger. According to the air inverse model, the calculation of the target throttle opening is carried out so as to make a current air quantity reach the target air quantity most quickly. Therefore, the throttle comes to be opened up to the maximum opening so as to increase rapidly an air quantity in a situation where an actual torque is insufficient for the required torque.

It is assumed that a temporary release operation of the accelerator pedal is performed by a driver in these situations. The operation is reflected to the required torque, and thereby the required torque decreases temporarily. However, in the situation where there is a large gap between the required torque and the current torque, the current torque is still insufficient for the required torque even if the required torque decreases in some degree. Therefore, the target throttle opening calculated with use of the air inverse model remains in the maximum opening, and the current torque continues to increase monotonically toward the required torque. As a result, the driver can not get an expected feeling of deceleration, and will feel uncomfortable.

The required torque includes a torque which the driver requests through an operation of the accelerator pedal and a torque which a vehicle-control device like ECT (Electronic Controlled Transmission), TRC (Traction Control System) and so on requests for vehicle control. Because of this, a temporary decrease in the required torque during acceleration may be caused by a torque reduction request from the vehicle-control device as well as the temporary release operation of the accelerator pedal. However, the target throttle opening calculated with use of the air inverse model remains in the maximum opening when there is a large gap between the required torque and the current torque. This may cause the torque reduction request from the vehicle-control device not to be reflected to the throttle opening.

### CITATION LIST

### Patent Literature

Patent Literature 1: Japanese Patent Laid-Open No. 2010-053705

Patent Literature 2: Japanese Patent Laid-Open No. 2010-223046

### SUMMARY OF INVENTION

An object of the present invention is to improve torque controllability in a situation where there is a gap between a required torque and a current torque based on a supercharge delay of a supercharger when calculation of a target throttle opening using an air reverse model is applied to a supercharged internal combustion engine. Then, in order to achieve this object, the present invention provides a control unit of a supercharged internal combustion engine as follows.

According to one aspect of the present invention, the control unit receives a required torque which a driver or a vehicle-control device requests the internal combustion engine to output, and sets, referring to the required torque, a target torque to be outputted by the internal combustion engine. Then, the control unit calculates a target air quantity from the target torque, and calculates a target throttle opening based on the target air quantity with use of the air inverse model. With the exception of a certain situation which will be described later, that is, under a normal situation, the control unit sets the target torque at the required torque. This is for calculating the target throttle opening for realizing the required torque most quickly. However, when a change in the decreasing direction occurs in the required torque in a situation where there is a gap between the required torque and the current torque caused by a supercharge delay that occurs at the time of acceleration, the control units sets the target torque in an unusual manner. In this case, the control unit sets the target torque at a value being lower than the current torque.

The current torque during acceleration is the maximum torque which the internal combustion engine can generate at this time. Therefore, when the required torque is used as the target torque, a decrease in the required torque in a region higher than the current torque is not reflected to the throttle opening. However, setting the target torque as described above makes it possible to reduce the torque outputted by the internal combustion engine in response to the decrease in the required torque. As a result, when the decrease in the required torque is due to an accelerator pedal operation performed by the driver, the driver can get a desired feeling of deceleration. Further, when the decrease in the required torque is due to a torque reduction request from the vehicle-control device, a required vehicle control is performed accurately.

When setting the target torque at a value being lower than the current torque, it is preferable to set the target torque in the following method. First, when a change in the decreasing direction occurs in the required torque in a situation where there is a gap between the required torque and the current torque, the control unit sets a target amount of decrease in torque depending on an amount of decrease in the required torque. As a specific calculation method of the target amount of decrease in torque, for example, it is preferable to calculate a ratio of the current torque to the required torque before decrease and set the target amount of decrease in torque at a value obtained by correcting the amount of decrease in the required torque with use of the ratio as a correction coefficient. Then, the control unit sets the target torque at a value obtained by subtracting the target amount of decrease in torque from the current torque.

According to the method of setting the target torque as described above, an actual amount of decrease in the engine output torque is adjusted in accordance with the amount of decrease in the required torque. Therefore, when the decrease in the required torque is due to the accelerator pedal operation performed by the driver, the vehicle can generate a deceleration more matching the expectation of the driver. Further, when the decrease in the required torque is due to the torque reduction request from the vehicle-control device, the required vehicle control is performed more accurately.

By the way, there is a case where one or more actuators, which relate to the air quantity, other than the throttle are equipped to the supercharged internal combustion engine. For example, a variable valve timing apparatus for changing valve timing, a variable nozzle or a waste gate valve for varying boost pressure, and the like. These actuators adjust the air quantity in cooperation with the throttle. However, each of these actuators has a low response of the air quantity to the operation thereof as compared with the throttle. When the control object is the supercharged internal combustion engine having such an actuator, the following method is preferable as the operation of the actuator by the control unit.

According to a first preferred method, the control unit sets a target actuator value based on the required torque and operates the actuator in accordance with the target actuator value. That is, the control unit applies the operation based on the above-described target torque only to the throttle and sets the target values of the other actuators which adjust the air quantity in cooperation with the throttle based on the required torque itself instead of the target torque. According to the operation of the actuator based on the required torque, in a situation where there is a gap between the required torque and the current torque caused by a supercharge delay, the actuator continues to operate in the direction in which the air quantity increases even if the required torque somewhat reduces. This makes it possible to prevent a delay from occurring in the response of the air quantity when the required torque, which decreased once, begins to increase again. Further, the throttle has a high response of the air quantity to the operation thereof as compared with the other actuators. Therefore, operating the throttle on the basis of the target torque determined as described above makes it possible to decrease the air quantity rapidly to match the decrease in the required torque, and furthermore, makes it possible to increase the air quantity rapidly when the required torque begins to increase again.

According to a second preferred method, the control unit sets a target actuator value based on a torque obtained by removing a torque required by the vehicle-control device from the required torque and operates the actuator in accordance with the target actuator value. According to this method, the torque reduction request from the vehicle-control device is not applied to the operation of the actuator, and therefore, the actuator continues to operate during acceleration in the direction in which the air quantity increases. In this way, as with the first method, it is possible to prevent a delay from occurring in the response of the air quantity when the required torque, which decreased once, begins to increase again. Also, according to this method, the torque reduction request from the vehicle-control device is applied to the operation of the throttle. Since the throttle has a high response of the air quantity to the operation thereof, this makes it possible to decrease the air quantity rapidly to match the torque reduction request, and furthermore, makes it possible to increase the air quantity rapidly to match the torque increase request after the torque reduction request.

When the target amount of decrease in torque which is set depending on the amount of decrease in the required torque is too large although the response of the air quantity to the operation of the throttle is high, the air quantity may not be fully reduced to a quantity required to achieve the target amount of decrease in torque. That is, there is a possibility that an air quantity obtained by operating the throttle according to the target throttle opening becomes too much against an air quantity required to achieve the target torque. In such a case, combining the air quantity control using the throttle with the ignition timing control using an ignition device makes it possible to reliably achieve the target torque. Thus, according to a more preferred embodiment of the present invention, the control unit is provided with a function of adjusting the torque outputted by the internal combustion engine to the target torque by retarding an ignition timing with respect to an optimal ignition timing.

According to another aspect of the present invention, the control unit sets a target torque to be outputted by the internal combustion engine by referring to an operation position of an accelerator pedal operated by a driver. Then, the control unit calculates a target air quantity from a target torque, and calculates a target throttle opening based on the target air quantity with use of the air inverse model. The control unit generally sets the target torque depending on the operation position of the accelerator pedal operated by the driver. That is, under a normal situation which excludes a certain situation which will be described later, the control unit sets the target torque depending on the operation position of the accelerator pedal. This is for calculating the target throttle opening for realizing an acceleration request from the driver. However, when the accelerator pedal is stepped on by the driver and then is released in the middle of following acceleration, the control units sets the target torque in an unusual manner. In this case, the control unit sets the target torque at a value being lower than the current torque.

Setting the target torque as described above makes it possible to decrease the engine output torque in accordance with the release operation of the accelerator pedal performed by the driver. By this, the torque reduction which the driver requests to the internal combustion engine via the operation of the accelerator pedal is achieved, and a desired feeling of deceleration is given to the driver. In this case, it is more preferable to set a target amount of decrease in torque depending on a released amount of the accelerator pedal and set the target torque at a value obtained by subtracting the target amount of decrease in torque from the current torque. According to this, the actual amount of decrease in torque that the internal combustion engine outputs is adjusted in accordance with the amount of decrease in the required torque, and therefore, the vehicle can generate a deceleration more matching the expectation of the driver.

### BRIEF DESCRIPTION OF DRAWINGS

FIG. 1 is a block diagram showing a configuration of a control unit of a supercharged internal combustion engine according to a first embodiment of the present invention.

FIG. 2 is a flowchart illustrating a method of setting a target torque.

FIG. 3 is a diagram illustrating a concrete example of the calculation of the target torque.

FIG. 4 is a time chart showing the operation image during acceleration of the supercharged internal combustion engine which is controlled by the control unit configured as shown in FIG. 1.

FIG. 5 is a block diagram showing a configuration of a control unit of a supercharged internal combustion engine according to a second embodiment of the present invention.

FIG. 6 is a time chart showing the operation image during acceleration of the supercharged internal combustion engine which is controlled by the control unit configured as shown in FIG. 5.

FIG. 7 is a block diagram showing a configuration of a control unit of a supercharged internal combustion engine according to a third embodiment of the present invention.

### DESCRIPTION OF EMBODIMENTS

### First Embodiment

The first embodiment of the present invention will be described with reference to the drawings.

An internal combustion engine which the control unit of the present embodiment is applied to is a supercharged internal combustion engine for a vehicle, in particular, a spark ignition type four-cycle reciprocal engine equipped with a turbocharger, in more detail, an internal combustion engine having an electronic-controlled throttle (hereinafter referred to as throttle simply), a variable valve timing apparatus changing valve timing of an intake valve (hereinafter referred to as IN-VVT), and a waste gate valve (hereinafter referred to as WGV). The control unit is implemented as a function of an ECU (Electronic control unit) which is provided to the internal combustion engine. For details, the ECU functions as the control unit when a program stored in a memory is executed by a CPU. When the ECU functions as the control unit, the ECU controls the operation of each actuator including the throttle according to a programmed actuator control logic.

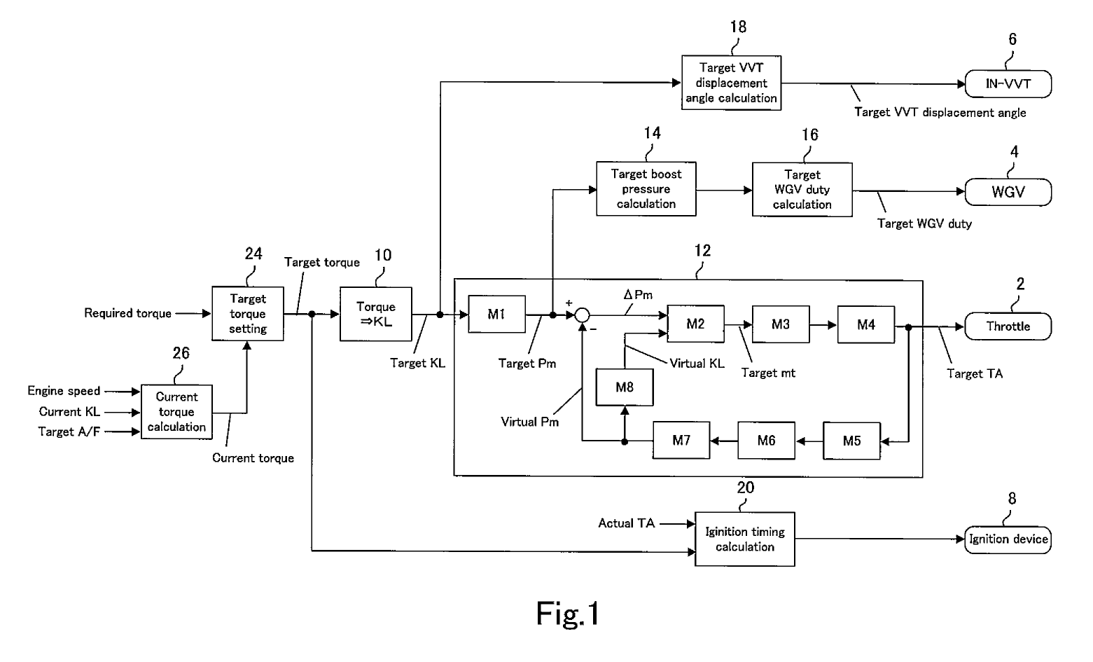

FIG. 1 is a functional block diagram showing a configuration of the control unit which is realized when the ECU functions according to the actuator control logic. The control unit acquires a required torque, and sets a target torque by referring to the required torque. The required torque includes a driver request torque calculated from an operation position of an accelerator pedal operated by a driver and a device request torque ordered from a vehicle-control device such as a ECT, TRC and the like. A method of setting the target torque based on the required torque will be described later in detail. The control unit calculates respective target actuator values of the throttle 2, WGV4, IN-VVT6 and ignition device 8 on the basis of the target torque. A method of calculating the target actuator value of each actuator according to the control unit will be described as follows.

First, a method of calculating the target actuator value of the throttle 2 according to the control unit will be described. A throttle opening is used as the actuator value of the throttle 2. The control unit calculates a target throttle opening (denoted as target TA in the figure) from the target torque with use of an air quantity conversion map 10 and an air inverse model 12. The air quantity conversion map 10 is a map in which torque is associated with cylinder intake air quantity (or load factor or filling efficiency obtained by making it non-dimensional) by using a variety of engine state quantities including engine speed, ignition timing and air-fuel ratio as keys. By the air quantity conversion map 10, a cylinder intake air quantity which is required to achieve the target torque under the current engine state quantities is calculated as a target air quantity (denoted as target KL in the figure).

The control unit calculates the target throttle opening by imputing the target air quantity into the air inverse model 12. More specifically, the air inverse model 12 is configured by combining an intake valve inverse model M1, an intake manifold inverse model M2, a throttle inverse model M3, a throttle operation inverse model M4, a throttle operation model M5, a throttle model M6, an intake manifold model M7, and an intake valve model M5. The throttle model M6, the intake manifold model M7, and the intake valve model M8 constitute a simple air model.

The intake valve inverse model M1 is a model created based on an experiment in which a relation of a cylinder intake air quantity and an intake manifold pressure is investigated. By an empirical rule which is obtained by the experiment, the relation of the cylinder intake air quantity and the intake manifold pressure is approximated by a straight line or a broker line in the intake valve inverse model M1. By inputting the target intake air quantity into the intake valve inverse model M1, a target intake manifold pressure (denoted as target Pm in the figure) for realizing the target intake air quantity is calculated.

The intake manifold inverse model M2 is a physical model which is constructed based on the conservation law concerning air in the intake manifold, more specifically, the energy conservation law and the flow rate conservation law. In the intake manifold inverse model M2, a relation of a flow rate of air passing through the throttle and an intake manifold pressure is expressed by a mathematical formula. The intake manifold inverse model M2 receives an input of a virtual air quantity (denoted as virtual KL in the figure) at present and a pressure difference (denoted as ΔPm in the figure) between the target intake manifold pressure and a virtual intake manifold pressure (denoted as virtual Pm in the figure) at present as main information. The intake manifold inverse model M2 calculates a target throttle-passing flow rate (denoted as target mt in the figure) for realizing the target intake manifold pressure based on the inputted information.

The throttle inverse model M3 is a model which expresses a relation of a throttle-passing flow rate and a throttle opening by a mathematical formula. Specifically, an equation of the throttle model is formed by expressing the throttle-passing flow rate as a function of a flow section area determined by the throttle opening and a pressure ratio between the upstream side and downstream side of the throttle, and an equation of the throttle inverse model is obtained by deforming the equation of the throttle model into an expression of the throttle opening. The pressure ratio used in this equation may be a measured value or a calculated value by a model. In the throttle inverse model M3, the target throttle-passing flow rate is inputted, whereby, a throttle opening for realizing the target throttle-passing flow rate is calculated.

The throttle operation inverse model M4 is a model in which a relation of an operation of the throttle and an input signal causing the operation is approximated by a formula and the like. In the throttle operation inverse model M4, the throttle opening calculated by the throttle inverse model M3 is inputted, whereby, an input signal for realizing it, that is, a target throttle opening is calculated.

The throttle operation model M5, throttle model M6, intake manifold model M7, and intake valve model M8 are provided in order to calculate the virtual intake manifold pressure and the virtual air quantity used in the calculation process described above. The throttle operation model M5 is a forward model corresponding to the throttle operation inverse model M4 described above. In the throttle operation model M5, the target throttle opening is inputted, whereby, a virtual throttle opening at present is calculated. The throttle model M6 is a forward model corresponding to the throttle inverse model M3 described above, and calculates a virtual throttle-passing flow rate (denoted as virtual mt in the figure) at present responding to an input of the virtual throttle opening. The intake manifold model M7 is a forward model corresponding to the intake manifold inverse model M2 described above, and calculates the virtual intake manifold pressure responding to an input of the virtual throttle-passing flow rate. The intake valve model M8 is a forward model corresponding to the intake valve inverse model M1 described above, and calculates the virtual air quantity responding to an input of the virtual intake manifold pressure. As described above, the virtual intake manifold pressure is used to calculate the pressure difference (ΔPm), and the virtual air quantity is inputted into the intake manifold inverse model M2 with the pressure difference.

The control unit operates the throttle 2 according to the target throttle opening calculated by the air inverse model 12 described above. An opening of the throttle 2, which is actually realized by the operation, is measured by a throttle opening sensor (not shown).

Then, a method of calculating the target actuator value of the WGV 4 according to the control unit will be described. A duty of a solenoid for opening and closing the WGV 4 is used as the actuator value of the WGV 4. The control unit calculates a target duty of the WGV 4 (denoted as target WGV duty in the figure) from the target intake manifold pressure with use of a boost pressure calculation map 14 and a duty calculation map 16. The boost pressure calculation map 14 is a map in which intake manifold pressure is associated with boost pressure required to realize it by using a variety of engine state quantities as keys. The control unit calculates a target boost pressure based on the target intake manifold pressure with use of the boost pressure calculation map 14. The duty calculation map 16 is a map in which boost pressure is associated with duty required to realize it by using a variety of engine state quantities as keys. The control unit calculates a target WGV duty based on the target boost pressure with use of the duty calculation map 16, and operates the WGV 4 according to the target boost pressure.

Then, a method of calculating the target actuator value of the IN-VVT 6 according to the control unit will be described. A displacement angle of the IN-VVT 6 is used as the actuator value of the IN 6. The control unit calculates a target displacement angle of the IN-VVT 6 (denoted as target VVT displacement angle in the figure) from the target air quantity with use of a VVT inverse model 18. The VVT inverse model 18 is an inverse model of a VVT model which is made by modeling the response characteristic of the air quantity to the displacement angle of IN-VVT 6. According to the VVT inverse model 18, a displacement angle for achieving the target air quantity most quickly is calculated as the target displacement angle. The control unit operates the IN-VVT 6 according to the target displacement angle calculated with use of the VVT inverse model 18.

Finally, a method of calculating the target actuator value of the ignition device 8 according to the control unit will be described. An ignition timing, more particularly, a retard amount relative to an optimum ignition timing (the more retarding of a trace knock ignition timing or a MBT) which is determined from the engine state is used as the actuator value of ignition device 8. The control unit controls the torque by combination with the ignition timing control by the ignition device 8 and the above-mentioned air quantity control by the cooperation of the throttle 2, WGV 4, and IN-VVT 6. However, on the viewpoint of fuel economy, torque control by the air quantity is used as a main control, and torque control by the ignition timing is performed for the purpose of complementing the torque control by the air quantity. Specifically, the ignition timing is basically set at the optimum ignition timing, and is made retarded only when the actual torque becomes excessive relative to the target torque if performing only the torque control by the air quantity.

The control unit calculates a target ignition timing with use of an ignition timing calculating unit 20. The ignition timing calculating unit 20 is provided with engine state quantities indicating the present engine state in addition to the throttle opening (denoted as actual TA in the figure) measured by a throttle opening sensor. The ignition timing calculating unit 2 calculates, based on these engine state quantities, an estimated torque which is to be obtained when the ignition timing is set at the optimum ignition timing. When the estimated torque is equal to or less than the target torque, the optimum ignition timing is calculated as the target ignition timing by the ignition timing calculating unit 2. However, when the estimated torque is greater than the target torque, the ignition timing calculating unit 20 sets a retard amount of the ignition timing required to achieve the target torque based on the ratio or difference between the target torque and the estimated torque. Then, the ignition timing calculating unit 20 calculates as the target ignition timing an ignition timing retarded by the retard amount from the optimum ignition timing. The control unit 20 operates the ignition device 8 according to the target ignition timing calculated by the ignition timing calculating unit 20.

As described above, the control unit uses the target torque instead of the required torque as the basis information for calculating the target actuator value for each actuator. The target torque is set with reference to the required torque as mentioned above. As an element for setting the target torque based on the required torque, the control units comprises a target torque setting unit 24 and a current torque calculating unit 26.

The current torque calculating unit 26 is an element for calculating the current torque which the internal combustion engine currently outputs. The current torque calculating unit 26 is provided with engine state quantities indicating the present engine state such as an engine speed, current air quantity (current KL), target air-fuel ratio (target A/F) and so on. The engine state quantities may be measured values by sensors or calculated values. The current torque calculating unit 26 calculates the current torque currently outputted by the internal combustion engine with use of the engine state quantities.

The target torque setting unit 24 is provided with the required torque and the current torque calculated by the current torque calculating unit 26. The calculation of the required torque is performed by a power train manager (not shown). The power train manager, which is a control unit that performs integrated control of the entire vehicle, is realized as one function of the ECU in the same manner as the control unit. The calculation of the required torque by the power train manager and the calculation of the current torque by the control unit are carried out in a certain time step that corresponds to the operation cycle of the ECU. The target torque setting unit 24 sets the target torque based on the target torque and the current torque. FIG. 2 shows a flowchart of how to set the target torque by the target torque setting unit 24. Features of the target torque setting unit 24 will be described with reference to the flowchart of FIG. 2 as follows.

According to the flowchart of FIG. 2, first, the target torque setting unit 24 performs a determination in step S1. In step S1, the target torque setting unit 24 calculates a difference between the required torque and the current torque, and determines whether the difference is greater than a predetermined threshold or not. Although the throttle 2 is an actuator having a high response of the air quantity to the operation thereof as compared with the WGV 4 or the like, a slight delay in response occurs between the target air quantity and the actual air quantity. Therefore, the difference that occurs temporarily between the required torque and the current torque is a phenomenon that occurs not only in a supercharged internal combustion engine but also in a naturally-aspirated internal combustion engine. However, in the case of the supercharged internal combustion engine, a supercharge delay that occurs during acceleration causes a situation in which the current torque is largely deviated from the required torque. The threshold used in the determination in step S1 is set at a level by which a deviation of the current torque from the required torque caused by the supercharge delay can be detected.

When the difference between the require torque and the current torque exceeds the threshold value, then, the target torque setting unit 24 performs a determination in step S2. In step S2, the target torque setting unit 24 determines whether an amount of decrease in the required torque, in particular, an amount of decrease in the present value of the required torque from the last value is greater than a predetermined threshold or not. When a torque reduction request is generated from the driver or the vehicle-control device, the request is quantified as the magnitude of the amount of decrease in the required torque. The threshold used in the determination in step S2 is set at a level by which the torque reduction request from the driver or the like can be distinguished from a noise component contained in the required torque.

When a negative result is received in the determination in step 1, the target torque setting unit 24 executes a processing in step S4 as a processing for setting the target torque. Further, when a negative result is received in the determination in step 2 whereas a positive result is received in the determination in step 1, the target torque setting unit 24 executes the processing in step S4. In step S4, the target torque setting unit 24 sets the present value of the target torque (denoted as TRQtg(k) in the figure) at the present value of the required torque (denoted as TRQrq(k) in the figure) without change. After setting the target torque, the target torque setting unit 24 executes a processing in step S5. In step S5, the present value of the required torque is stored as the last value.

However, when a positive result is received in the determination in step 1, and a positive result is received in the determination in step 2 too, the target torque setting unit 24 executes a processing in step S3 as the processing for setting the target torque. In step S3, the target torque setting unit 24 sets a target amount of decrease in torque depending on the amount of decrease in the required torque, and sets the target torque at a value being lower than the current torque by the target amount of decrease in torque. More specifically, setting of the target torque is performed as follows. First, the target torque setting unit 24 calculates the amount of decrease in the present value of the required torque from the last value (denoted as ΔTRQ in the figure), and calculates a ratio of the last value of the current torque (denoted as TRQcr(k−1) in the figure) to the last value of the required torque (denoted as TRQrq(k−1) in the figure). Next, the target torque setting unit 24 calculates the target amount of decrease in torque by correcting the amount of decrease in the required torque with use of the ratio as a correction coefficient. Then, the target torque setting unit 24 sets the present value of the target torque (denoted as TRQtg(k) in the figure) at a value obtained by subtracting the target amount of decrease in torque from the last value of the required torque. After setting the target torque, the target torque setting unit 24 executes the processing in step S5.

According to the above method, under a normal condition, the target torque is set at the required torque so as to calculate the target throttle opening for realizing the required torque most quickly. However, when a torque reduction request is generated from the driver or the vehicle-control device in a situation where there is a gap between the required torque and the current torque caused by a supercharge delay, the target torque is calculated on the basis of the current torque so as to obtain a required amount of decrease in torque. A technical significance of setting the target torque according to the method described above will be described below with reference to a specific calculation example.

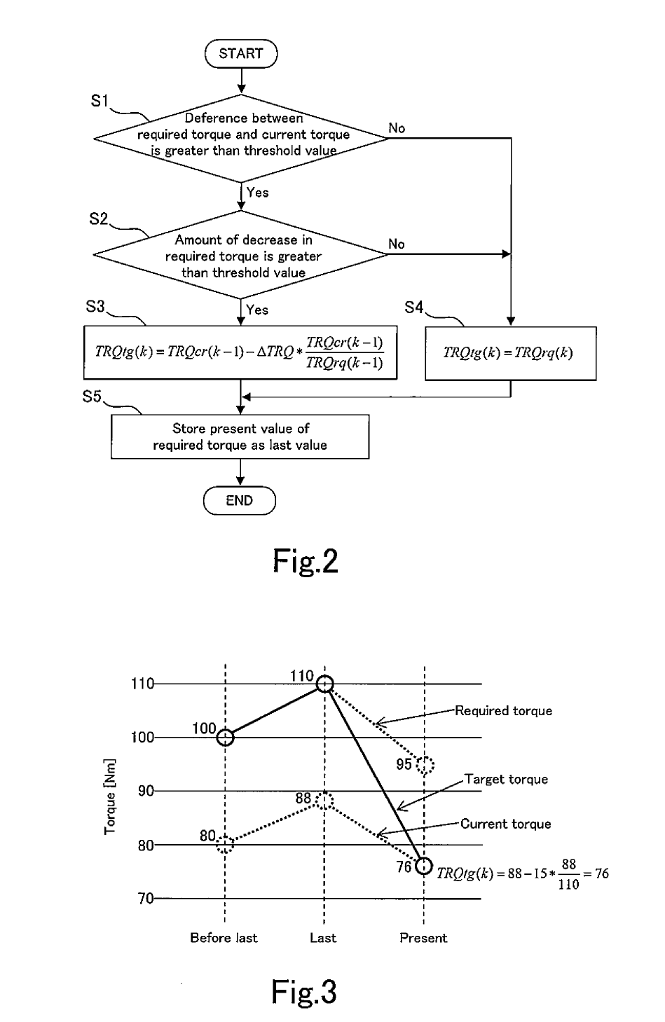

FIG. 3 is a diagram showing a specific example of calculation of the target torque according to the method described above. According to this figure, the required torque before last was 100 Nm, and the current torque before last was 80 Nm. At the last calculation time, the required torque was increased to 110 Nm and the current torque was increased to 88 Nm. In a situation where both the current torque and the required torque have been increasing while there is a deviation between the two in this way, the required torque has decreased to 95 Nm this time.

When the current torque and the required torque are changed as shown, the target torque had been set in the usual manner according to the processing in step S4 until the last calculation time. That is, the target torque before last was set at 100 Nm and the last target torque was set at 110 Nm. However, at this time when the request torque has been reduced, the calculation of the target torque is performed according to the processing in step S3. According to the formula used in step S3, since the amount of decrease in the required torque is 15 Nm and the ratio of the last value of the current torque to the last value of the required torque is 0.8, the target amount of decrease in torque becomes 12 Nm, which is obtained by multiplying the correction coefficient of 0.8 to 15 Nm. Then, the present value of the target torque is set at 76 Nm, which is obtained by subtracting the target amount of decrease in torque of 12 Nm from the last value of the current torque of 88 Nm.

Because the current torque during acceleration is the maximum torque that the internal combustion engine can generate at this time, when the required torque is used as the target torque without change, decrease in the required torque in a region higher than the current torque is not applied to the throttle opening. However, setting the present value of the target torque based on the last value of the current torque as described above makes it possible to decrease the torque outputted from the internal combustion engine so as to match the decrease in the required torque. According to the example shown in FIG. 3, the current torque can be decreased to the present value of 76 Nm from the last value of 88 Nm. Moreover, according to the formula used in step S3, the target torque is calculated so that the amount of decrease in the current torque becomes greater in response to the amount of decrease in the required torque being greater. As a result, when the decrease in the required torque is due to an accelerator pedal operation performed by the driver, the driver can get a desired feeling of deceleration. Further, when the decrease in the required torque is due to a torque reduction request from the vehicle-control device, a required vehicle control is performed accurately.

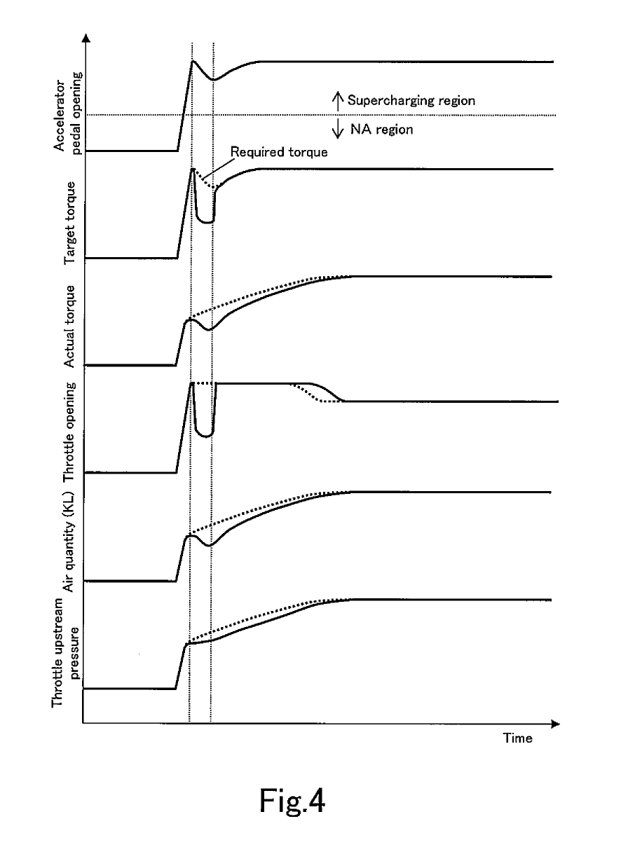

According to the control unit, the setting of the target torque is performed as above, whereby, the control results shown in a chart in FIG. 4 are obtained. FIG. 4 is a time chart showing the operation image during acceleration of the supercharged internal combustion engine which is controlled by the control unit against the operation image according to the comparative example. Here, a device using the required torque as the target torque directly, that is, a device configured by removing the target torque setting unit 24 and the current torque calculating unit 26 from the configuration shown in FIG. 1 is used as the comparative example.

FIG. 4 shows the control results obtained when the accelerator pedal is slightly released temporarily after the accelerator pedal is depressed to fully opening. In the highest chart of FIG. 4, temporal change in the accelerator pedal opening is indicated. In the second highest chart, temporal change in the target torque obtained by the control unit is indicated by a solid line, and temporal change in the target torque obtained by the comparative example, that is, temporal change in the required torque is indicated by a dotted line. In the third highest chart, temporal change in the actual torque obtained by the control unit is indicated by a solid line, and temporal change in the actual torque obtained by the comparative example is indicated by a dotted line. In the fourth highest chart, temporal change in the throttle opening obtained by the control unit is indicated by a solid line, and temporal change in the throttle opening obtained by the comparative example is indicated by a dotted line. In the fifth highest chart, temporal change in the cylinder intake air quantity obtained by the control unit is indicated by a solid line, and temporal change in the cylinder intake air quantity obtained by the comparative example is indicated by a dotted line. Then, in the lowest chart, temporal change in the throttle upstream pressure obtained by the control unit is indicated by a solid line, and temporal change in the throttle upstream pressure obtained by the comparative example is indicated by a dotted line.

First, the control results obtained by the comparative example will be described. According to the comparative example, the required torque that is calculated from the accelerator pedal opening is set to the target torque without change, and the operation of the throttle is performed according to the target torque that is the required torque itself. When the accelerator pedal is depressed, the throttle is opened up to the maximum opening. This makes the air quantity rise rapidly for a moment. However, when the operation moves from a NA region where supercharging by the supercharger is not performed to a supercharging region where supercharging is performed, a rate of increase in the air quantity becomes slow by the supercharge delay, that is, the delay of increase in the throttle upstream pressure. As a result, a situation where there is a large gap between the target torque and the actual torque generated from the internal combustion engine is produced. In this case, according to the calculation of the target throttle opening by the air inverse model described above, the maximum opening of the throttle is calculated as the target throttle opening in order to make the current torque reach the target torque at a maximum rate. When the accelerator pedal is released slightly temporarily in this situation, the target torque, which is the required torque itself, is reduced by an amount corresponding to the release amount of the accelerator pedal. However, since there is no change in the situation where there is a gap between the target torque and the current torque even if the target torque is somewhat reduced, the throttle opening remains sticking to the maximum opening. As a result, the air quantity continues to increase monotonically without decreasing, and the torque that the internal combustion engine outputs continues to increase monotonically in accordance with it. That is, according to the comparative example, the release operation of the accelerator pedal performed by the driver is not reflected to the operation of the throttle, and as a result, is not reflected to the torque that the internal combustion engine outputs.

In contrast, according to the control unit, control results as follows are obtained. According to the control unit, usually as with the comparative example, the required torque that is calculated from the accelerator pedal opening is set to the target torque without change, and the operation of the throttle is performed according to the target torque. However, when a release operation of the accelerator pedal is performed in a situation where there is a gap above a certain level between the target torque and the torque that the internal combustion engine outputs, the target torque is set based on the current torque, that is, the maximum torque that the internal combustion engine can output at the present time. The target torque to be set here is a value lower than the current torque by the target amount of decrease in torque determined in accordance with the amount of decrease in the required torque. Therefore, according to the calculation of the target throttle opening by the air inverse model described above, the target throttle opening is reduced from the maximum opening to the opening corresponding to the target torque so as to decrease the current torque to the target torque that is lower than the current torque. As a result, the throttle is operated in the close direction temporarily, and the air quantity decreases temporarily. This causes a temporary reduction in torque that the internal combustion engine outputs. In sum, according to the control unit, the release operation of the accelerator pedal performed by the driver is reflected to the operation of the throttle, and as a result, is reflected to the torque that the internal combustion engine outputs. Incidentally, a rate of rise in the throttle upstream pressure of the control unit is slightly slower than that of the comparative example. This is because the throttle is closed temporarily as described above. Further, according to the control unit, a situation where there is a gap between the target torque and the current torque continues slightly longer than the case of the comparative example because the air quantity is reduced once. Therefore, the period when the throttle opening sticks to the maximum opening becomes longer.

### Second Embodiment

Next, the second embodiment of the present invention will be described with reference to the drawings.

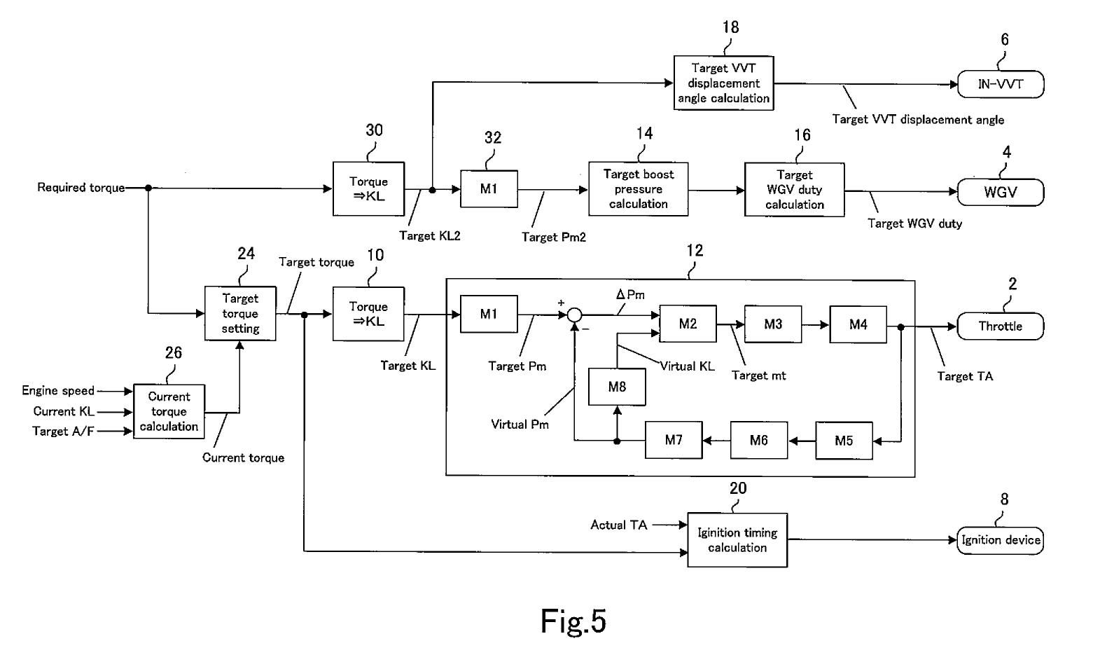

FIG. 5 is a functional block diagram showing a configuration of the control unit of the second embodiment of the present invention. The control unit of the second embodiment corresponds to a partially modified configuration of that of the first embodiment. Therefore, among the elements constituting the control unit of the second embodiment, the elements having functions common to that of the first embodiment are assigned with the same reference numerals in the figure. Hereinafter, whereas describing functions in common with the first embodiment will be simplified or omitted, the configuration of the control unit of the second embodiment will be described with a focus on functions different from the first embodiment.

The difference between the control unit of the second embodiment and that of the first embodiment is in a torque value used for setting respective target actuator values of the WGV 4 and IN-VVT 6. The control unit sets the respective target actuator values of the WGV 4 and IN-VVT 6 based on the required torque rather than the target torque set by the target torque setting unit 24. As for the throttle 2, as with the first embodiment control unit, the target throttle opening is set based on the target torque set by the target torque setting unit 24.

Therefore, the control unit comprises an air quantity conversion map 30 to convert the required torque into an air quantity in addition to the air quantity conversion map 10. By the air quantity conversion map 30, a cylinder intake air quantity which is required to achieve the required torque under the current engine state quantities is calculated as a target air quantity (denoted as target KL2 in the figure). In the control unit, the target air quantity converted from the required torque is inputted to the VVT inverse model 18, and a target displacement angle of the IN-VVT 6 is calculated based on the target air quantity. Further, the control unit comprises a separate intake valve inverse model 32 having the same content as the intake valve inverse model M1 of the air inverse model 12. The target air quantity converted from the required torque by using the air quantity conversion map 30 is inputted into the intake valve inverse model 32. Then, a target intake manifold pressure (denoted as target Pm2 in the figure) calculated by the intake valve inverse model 32 is converted into a target boost pressure by using the boost pressure calculation map 14, and also, is converted into a target WGV duty of the WGV 4 by using the duty calculation map 16.

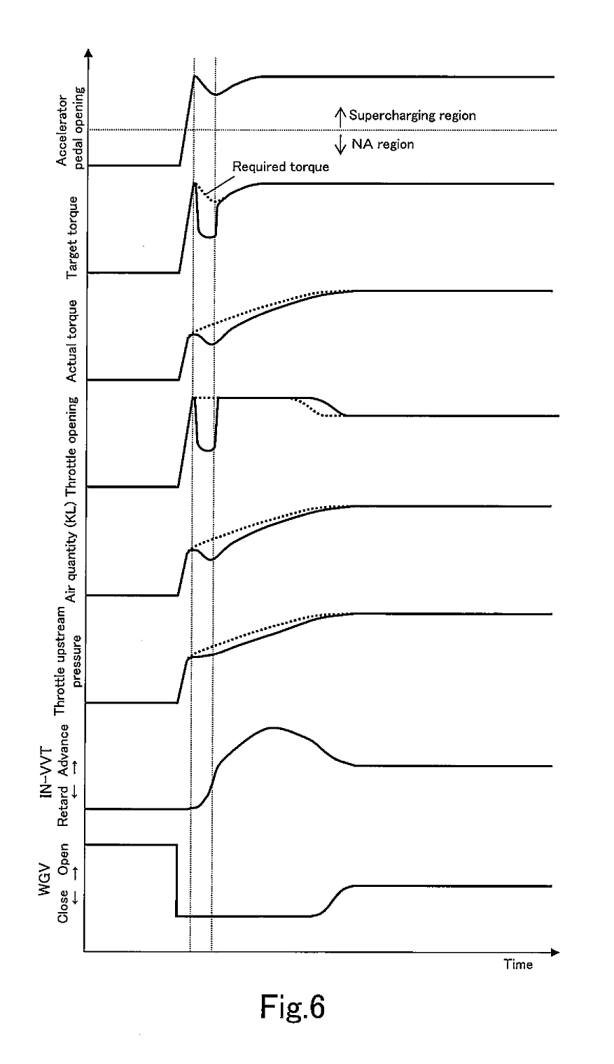

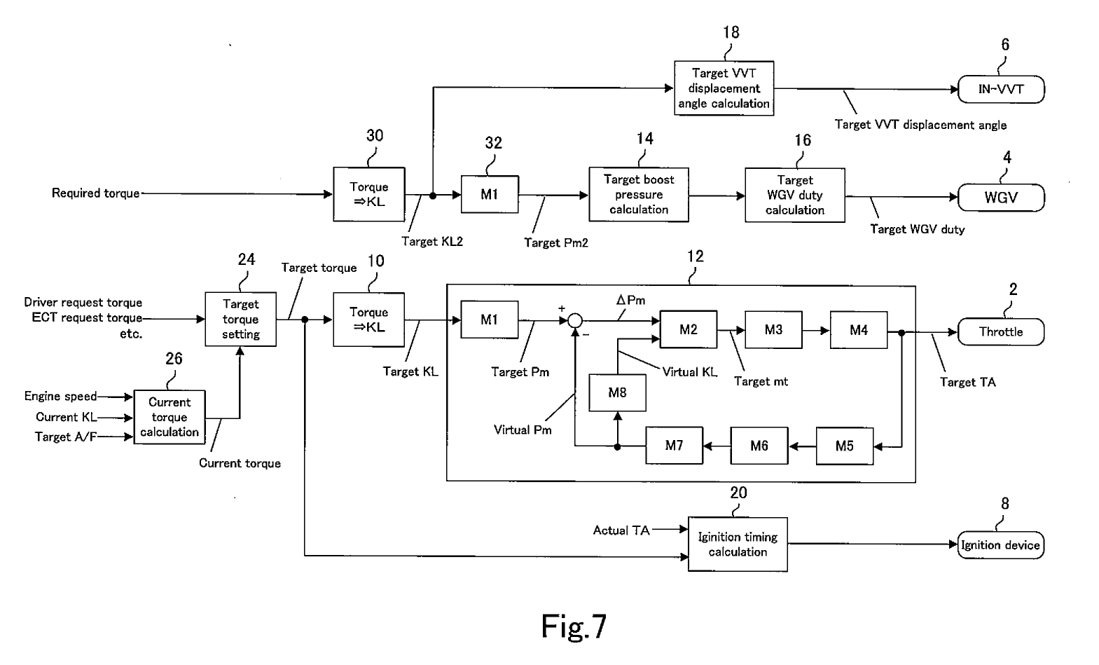

FIG. 6 is a time chart showing the operation image during acceleration of the supercharged internal combustion engine which is controlled by the control unit. The time chart in FIG. 6 corresponds to the time chart in FIG. 4 including a chart showing temporal change in the displacement angle of the IN-VVT 6 by the control unit and a chart showing temporal change in the opening of WGV 4.

The WGV 4 and IN-VVT 6 are actuators to adjust the air quantity in cooperation with the throttle 2. However, these actuators have a low response of the air quantity to the operation thereof as compared with the throttle 2. Therefore, when the WGV 4 and IN-VVT 6 are operated in the direction of decreasing the air quantity in response to the torque reduction request during acceleration, a little delay may occur in the response of the air quantity if the required torque, which decreased once, begins to increase again. However, according to the control unit, in a situation where there is a gap between the required torque and the current torque caused by a supercharge delay, as shown in the respective charts of the WGV 4 and IN-VVT 6, the WGV 4 and IN-VVT 6 continue to operate in the direction in which the air quantity increases even if the required torque reduces in response to the torque reduction request. This makes it possible to prevent a delay from occurring in the response of the air quantity when the required torque, which decreased once, begins to increase again. Further, the throttle 2 is operated on the basis of the target torque as with the case of the first embodiment. This makes it possible to decrease the air quantity rapidly to match the decrease in the required torque, and furthermore, makes it possible to increase the air quantity rapidly when the required torque begins to increase again.

### Third Embodiment

Next, the third embodiment of the present invention will be described with reference to the drawings.

FIG. 7 is a functional block diagram showing a configuration of the control unit of the third embodiment of the present invention. The control unit of the third embodiment corresponds to a partially modified configuration of that of the second embodiment. Therefore, among the elements constituting the control unit of the third embodiment, the elements having functions common to that of the second embodiment are assigned with the same reference numerals in the figure. Hereinafter, whereas describing functions in common with the second embodiment will be simplified or omitted, the configuration of the control unit of the third embodiment will be described with a focus on functions different from the second embodiment.

The difference between the control unit of the third embodiment and that of the second embodiment is in a torque value used for setting respective target actuator values of the WGV 4 and IN-VVT 6. The control unit sets the respective target actuator values of the WGV 4 and IN-VVT 6 not based on the required torque but based on only the driver request torque included in the required torque, that is, a required torque calculated from the accelerator pedal. As for the throttle 2, as with the first embodiment control unit, the target torque is set by the target torque setting unit 24 with reference to the required torque that includes not only the driver request torque but also the request torque ordered from the vehicle-control device such as the ECT, and then, the target throttle opening is set based on the target torque.

In the control unit, the driver request torque is converted into the target air quantity (denoted as target KL2 in the figure) by using the air quantity conversion map 30. Then, the target air quantity converted from the driver request torque is inputted to the VVT inverse model 18, and the target displacement angle of the IN-VVT 6 is calculated based on the target air quantity. Further, in the control unit, the target air quantity converted from the driver request torque by using the air quantity conversion map 30 is inputted into the intake valve inverse model 32.

Then, the target intake manifold pressure (denoted as target Pm2 in the figure) calculated by the intake valve inverse model 32 is converted into the target boost pressure by using the boost pressure calculation map 14, and also, is converted into the target WGV duty of the WGV 4 by using the duty calculation map 16.

According to the control unit of the present embodiment configured as described above, the torque reduction request from the vehicle control device such as the ECT is not reflected to the operation of the WGV 4 and IN-VVT 6, and is reflected to only the operation of the throttle 2. This prevents the WGV 4 and IN-VVT 6 from operating uselessly, and makes it possible to prevent a delay from occurring in the response of the air quantity when the required torque, which decreased once in response to the torque reduction request, begins to increase again.

### Others.

The embodiments of the present invention are described above, but the present invention is not limited to the aforementioned embodiments, and can be carried out by being variously modified within the range without departing from the gist of the present invention. For example, the WGV and IN-VVT are not essential with respect to the first embodiment. The control unit according to the first embodiment can be applied to a supercharged internal combustion engine having only the throttle without the WGV and IN-VVT. Also, in the above embodiment, the WGV and IN-VVT are exemplified as an actuator that adjusts the air quantity in cooperation with the throttle. However, a turbocharger with a variable nozzle and a variable valve timing apparatus for an exhaust valve may be considered to be included in such an actuator.

### DESCRIPTION OF REFERENCE NUMERALS

2 Throttle
4 Westgate valve
6 Variable valve timing apparatus
8 Ignition device
10 Air quantity conversion map
12 Air inverse model
14 Boost pressure calculation map
16 Duty calculation map
18 VVT inverse model
20 Ignition timing calculating unit
24 Target torque setting unit
26 Current torque calculating unit
M1 Intake valve inverse model
M2 Intake manifold inverse model
M3 Throttle inverse model
M4 Throttle operation inverse model
M5 Throttle operation model
M6 Throttle model
M7 Intake manifold model
M8 Intake valve model

1. A control unit of a supercharged internal combustion engine which has a throttle, the control unit comprising:
a target air quantity calculating unit that calculates a target air quantity from a target torque;
a target throttle opening calculating unit that calculates a target throttle opening based on the target air quantity with use of an air inverse model;
a throttle operating unit that operates the throttle according to the target throttle opening;
a required torque acquiring unit that acquires a required torque for the internal combustion engine;
a current torque calculating unit that calculates a current torque that is outputted from the internal combustion engine; and
a target torque setting unit that sets the target torque at the required torque when the required torque corresponds to the current torque, and setting the target torque at a value being lower than the current torque when a reduction direction change occurs in the required torque while there is a gap between the required torque and the current torque.

2. The control unit of a supercharged internal combustion engine according to claim 1,
wherein the target torque setting unit, when a reduction direction change occurs in the required torque while there is a gap between the required torque and the current torque, sets a target amount of decrease in torque depending on an amount of decrease in the required torque, and sets the target torque at a value obtained by subtracting the target amount of decrease in torque from the current torque.

3. The control unit of a supercharged internal combustion engine according to claim 2,
wherein the target torque setting unit sets the target amount of decrease in torque at a value obtained by correcting the amount of decrease in the required torque with a ratio of the current torque to the required torque before decrease.

4. The control unit of a supercharged internal combustion engine according to claim 1,
wherein the internal combustion engine has an actuator that adjusts an air quantity in cooperation with the throttle, the actuator having a low response of the air quantity to the operation thereof as compared with the throttle; and
wherein the control unit further comprises:
a target actuator value setting unit that sets a target actuator value based on the required torque; and
an actuator operating unit that operates the actuator according to the target actuator value.

5. The control unit of a supercharged internal combustion engine according to claim 1,
wherein the internal combustion engine has an actuator that adjusts an air quantity in cooperation with the throttle, the actuator having a low response of the air quantity to the operation thereof as compared with the throttle; and
wherein the control unit further comprises:
a target actuator value setting unit that sets a target actuator value based on a torque obtained by removing a torque required by a vehicle-control device from the required torque; and
an actuator operating unit that operates the actuator according to the target actuator value.

6. The control unit of a supercharged internal combustion engine according to claim 1, further comprising:
a torque adjusting unit that adjusts a torque outputted from the internal combustion engine to the target torque by retarding an ignition timing with respect to an optimum ignition timing when an air quantity obtained by operating the throttle according to the target throttle opening exceeds an air quantity necessary to achieve the target torque.

7. A control unit of a supercharged internal combustion engine which has a throttle, the control device comprising:
a target air quantity calculating unit that calculates a target air quantity from a target torque;
a target throttle opening calculating unit that calculates a target throttle opening based on the target air quantity with use of an air inverse model;
a throttle operating unit that operates the throttle according to the target throttle opening;
an accelerator pedal position acquiring unit that acquires an operation position of an accelerator pedal operated by a driver;
a current torque calculating unit that calculates a current torque that is outputted from the internal combustion engine; and
a target torque setting unit that generally sets the target torque depending on the operation position of the accelerator pedal, but sets the target torque at a value being lower than the current torque when the accelerator pedal is stepped on by the driver and then is released in the middle of following acceleration.

8. The control unit of a supercharged internal combustion engine according to claim 7,
wherein the target torque setting unit, when the accelerator pedal is stepped on by the driver and then is released in the middle of following acceleration, sets a target amount of decrease in torque depending on a released amount of the accelerator pedal, and sets the target torque at a value obtained by subtracting the target amount of decrease in torque from the current torque.
